(19) United States
(12) Patent Application Publication
(10) Pub. No.: US 2013/0283966 A1
(43) Pub. Date: Oct. 31, 2013

(54) CENTRIFUGAL FORCE PENDULUM DEVICE

(71) Applicant: Schaeffler Technologies AG & Co., KG, Herzogenaurach (DE)

(72) Inventors: Florian Baral, Waldbronn (DE); David Schnaedelbach, Baden-Baden-Neuweier (DE)

(21) Appl. No.: 13/924,023

(22) Filed: Jun. 21, 2013

Related U.S. Application Data
(63) Continuation of application No. PCT/DE2011/002098, filed on Dec. 9, 2011.

(30) Foreign Application Priority Data
Dec. 24, 2010 (DE) 102010056163.0

(51) Int. Cl. F16F 15/30

(52) U.S. Cl. CPC F16F 15/30
USPC 74/574.2

(57) ABSTRACT

A centrifugal force oscillating device having oscillating masses that are situated axially on both sides of an oscillating mass carrier rotatable around an axis of rotation and form an oscillating mass pair, where the oscillating masses can be swiveled to a limited extent along an oscillation path opposite the oscillating mass carrier with the help of at least one roll-off element that can be rolled off in cut-outs in both the oscillating mass carrier and the oscillating masses, and where the oscillating masses can be moved to a limited extent axially relative to each other to form the oscillating mass pair, and where the oscillating masses of an oscillating mass pair are movable to a limited extent radially and/or circumferentially relative to each other.

### CROSS-REFERENCE TO RELATED APPLICATIONS

This application is filed under 35 U.S.C. §120 and §365(c) as a continuation of International Patent Application PCT/DE2011/002098, filed Dec. 9, 2011, which application claims priority from German Patent Application No. DE 10 2010 056 163.0, filed Dec. 24, 2010, which applications are incorporated herein by reference in their entireties.

### FIELD OF THE INVENTION

The invention relates to a centrifugal force oscillating device.

### BACKGROUND OF THE INVENTION

A centrifugal force oscillating device for damping and/or extinguishing torsional vibrations in a drive train of a motor vehicle is known from DE 10 2006 028 556 A1. The torsional vibrations can arise through the operation of a combustion engine and lead to unpleasant noises, vibrations, but also to failure of components. The centrifugal force oscillating device has oscillating masses that are situated axially on both sides of an oscillating mass carrier rotatable around an axis of rotation and form a pair of oscillating masses. The oscillating masses can be swiveled to a limited extent along an oscillation path opposite the oscillating mass carrier with the help of at least one rollable roll-off element that is received in cut-outs in both the oscillating mass carrier and the oscillating mass. The movement of the oscillating masses along the oscillation path takes place under the influence of the centrifugal force field, where the centrifugal force is the restoring force in the oscillating motion.

### BRIEF SUMMARY OF THE INVENTION

The oscillating masses are joined together to form the oscillating mass pair with the aid of spacing bolts, which permit a limited relative axial movability of oscillating masses, though they join the oscillating masses together rigidly in the circumferential direction and the radial direction.

The object of the invention is to improve the extinguishing effect of a centrifugal force oscillating device. In addition, the reliability of the centrifugal force oscillating device is to be increased.

Accordingly, a centrifugal force oscillating device having oscillating masses that are situated axially on both sides of an oscillating mass carrier rotatable around an axis of rotation and form an oscillating mass pair is proposed, where the oscillating masses can be swiveled to a limited extent along an oscillation path opposite the oscillating mass carrier with the help of at least one roll-off element that can be rolled off in cut-outs in both the oscillating mass carrier and the oscillating masses, and where the oscillating masses can be moved to a limited extent axially relative to each other to form the oscillating mass pair, and where the oscillating masses of an oscillating mass pair are movable to a limited extent radially and/or circumferentially relative to each other. This improves the extinguishing effect of the centrifugal force oscillating device, as the oscillating masses have additional freedom of movement. The reliability of the centrifugal force oscillating device can also be increased, since in the case of a collision of circumferentially adjacent oscillating masses, the oscillating masses of an oscillating mass pair can touch the circumferentially adjacent oscillating masses on the respective axial side of the oscillating mass carrier independently of each other.

Preferably, the oscillating masses of an oscillating mass pair are received on the oscillating mass carrier exclusively with the aid of the roll-off elements. As a result, the fastening elements and the cut-outs on the oscillating mass carrier for receiving the fastening elements can be eliminated. The maximum pivoting angle of the oscillating masses with respect to the oscillating mass carrier can be enlarged, and the cutouts for receiving the roll-off elements can be correspondingly larger.

In a preferred embodiment of the invention, the roll-off element accommodates a retainer on the side lying axially outside in relation to the oscillating mass, to limit maximum axial movement of the oscillating masses of an oscillating mass pair relative to each other. Advantageously, the retainer is fixed axially firmly on the roll-off element.

In a preferred form of the invention, the retainer is designed as a ring-shaped element. Preferably, the retainer can be secured axially in at least one direction by a locking ring accommodated in a recess in the roll-off element.

Advantageously, the retainer is movable circumferentially and/or radially together with the roll-off element, relative to the oscillating mass.

In another embodiment of the invention, a minimum axial distance between the oscillating masses and the oscillating mass carrier is defined by an axial projection formed on the oscillating mass carrier and/or on the lateral face of the oscillating mass that faces the oscillating mass carrier axially. Preferably, the axial projection is made in a single piece with the oscillating mass carrier or the oscillating mass.

Also, a minimum axial distance of the oscillating masses from the oscillating mass carrier can be defined by a collar formed on the roll-off element and located axially in each case between the oscillating mass and oscillating mass carrier and encircling the roll-off element.

The centrifugal force oscillating device can be situated on and/or in a hydrodynamic torque converter, on and/or in a clutch device, for example a wet-running clutch, a dual clutch, on a dual-mass flywheel or a torsional vibration damper.

Additional advantages and advantageous designs of the invention are derived from the description and the illustrations, in which accurately scaled representation has been dispensed with in the interest of clarity. All explained features are applicable not only in the indicated combination, but also in other combinations or by themselves, without going beyond the confines of the invention.

### BRIEF DESCRIPTION OF THE DRAWINGS

The invention will be described in detail below with reference to the illustrations. The following details are shown:

FIG. 1 is a side view of a centrifugal force oscillating device according to the state of the art;

FIG. 2 is a three-dimensional view of a detail of the centrifugal force oscillating device from FIG. 1;

FIG. 3 is a side view of a detail of a centrifugal force oscillating device in a special embodiment of the invention; and,

FIG. 4 is a three-dimensional view of a detail of the centrifugal force oscillating device from FIG. 3.

### DETAILED DESCRIPTION OF THE INVENTION

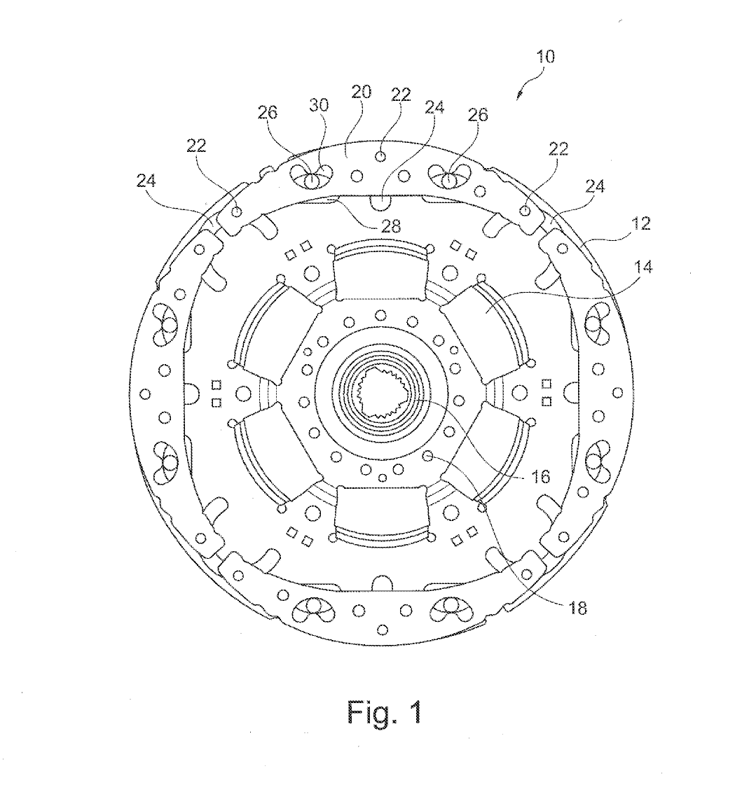

FIG. 1 shows a side view of a centrifugal force oscillating device 10 according to the state of the art. The centrifugal force oscillating device 10 comprises an oscillating mass carrier 12 rotatable around an axis of rotation, which is formed here as a component of a torsional vibration damper that acts to damp torsional vibrations. To that end, spring windows 14 are formed in the oscillating mass carrier to receive energy storage elements, for example coil springs. The energy storage elements are operatively connected to the oscillating mass carrier 12 and a damper component (not shown here) of the torsional vibration damper, to make it possible to rotate the damper component relative to the oscillating mass carrier 12 through the effect of the energy storage elements, to which end the latter may be brought into engagement with the damper component and the oscillating mass carrier.

Radially within the spring window 14 an output hub 16 is attached to the oscillating mass carrier 12, in particular riveted by means of rivet elements 18, the output hub 16 being non-rotatingly connectible to a transmission input shaft through gearing.

In a region of the oscillating mass carrier 12 located radially to the outside, four oscillating masses 20 are situated, each of which is joined with an axially opposing oscillating mass, not shown here, located on the other axial lateral face of the oscillating mass carrier 12, to form respective oscillating mass pairs. The joining of the axially opposing oscillating masses occurs with the aid of a total of three fastening elements 22 per oscillating mass pair, the fastening elements 22 being firmly connected to the oscillating masses 20 and extending through cut-outs 24 in the oscillating mass carrier 12.

The cut-outs 24 are shaped in this case so that a swiveling of the oscillating masses 20 relative to the oscillating mass carrier 12 along an oscillation path can be made possible. The oscillation path can preferably be described by a circular arc, to which end the cut-outs 24 are kidney-shaped and large enough so that the movement of the oscillating mass pair relative to the oscillating mass carrier 12 along the oscillation path is not interfered with by the fastening elements 22 abutting on the cut-outs 24. However, the fastening elements 22 can limit a maximum deflection of the oscillating masses 20 along the oscillation path by hitting the cut-outs 24 in respective circumferential end areas of the cut-outs 24.

The actual swiveling motion of the oscillating masses 20 relative to the oscillating mass carrier 12 to form the oscillation path is made possible by roll-off elements 26 and cut-outs 28, 30 appropriately formed in the oscillating mass carrier 12 and in the oscillating masses 20. To that end, for each oscillating mass pair two roll-off elements 26, for example rolling elements, in particular stepped bolts are received in the respective paths 28, 30 and can roll in them. The cut-outs 30 in the oscillating masses 20 of an oscillating mass pair are formed respectively complementarily to the cut-outs 28 in the oscillating mass carrier 12, so that a preferably circular-arc-shaped oscillation path can be described and traversed by the oscillating masses. In particular, the cut-out 28 in the oscillating mass carrier 12 is kidney-shaped to that end, and the cut-out 30 in the oscillating masses 20 is kidney-shaped and curved in the opposite direction.

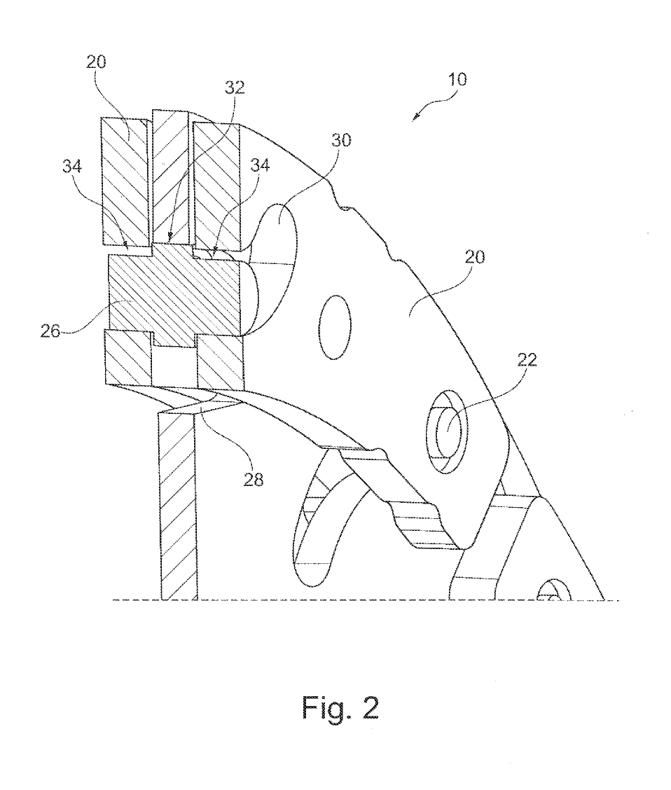

FIG. 2 shows a three-dimensional view of a detail of the centrifugal force oscillating device 10 according to the state of the art from FIG. 1. The roll-off elements 26 are in the form of stepped bolts, having a section 32 located in a receiving area of the cut-out 28 in the oscillating mass carrier 12 that has a larger outside diameter, the same as the sections 34 of the roll-off element 26 that are axially adjacent in the direction of the oscillating masses 20.

The fastening element 22 serves to fasten the oscillating masses 20 of an oscillating mass pair together, so that the oscillating masses 20 are axially fixed or limitedly movable relative to each other. The fastening element 22 thus represents a sort of securing unit, which keeps the oscillating masses 20 at a distance from each other axially.

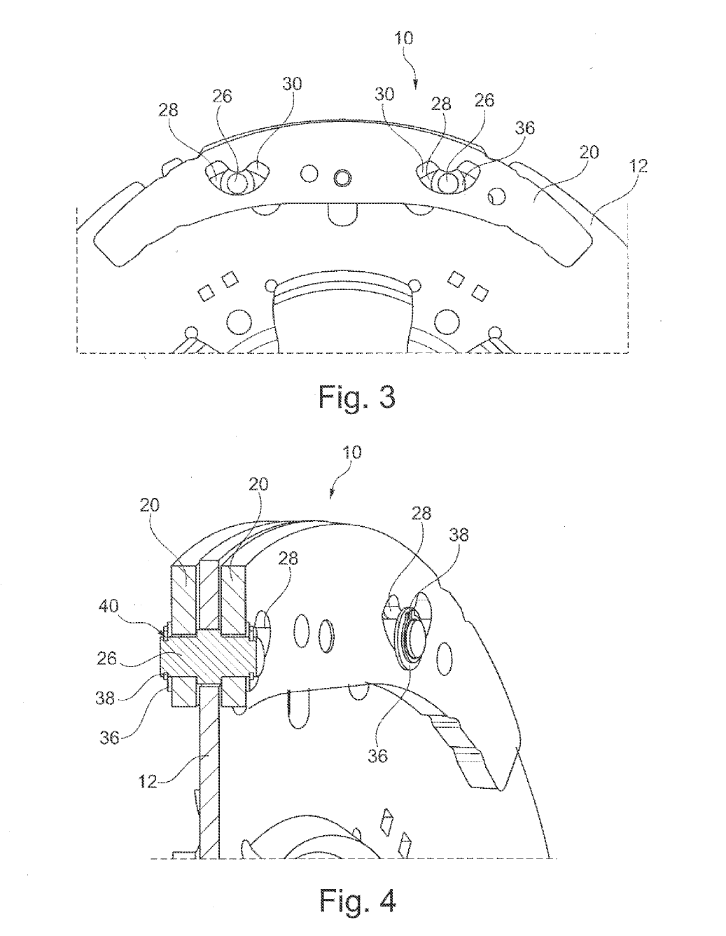

FIG. 3 shows a side view of a detail of a centrifugal force oscillating device 10 in a special embodiment of the invention. The oscillating mass 20, with an oscillating mass situated axially opposite with respect to the oscillating mass carrier 12, forms an oscillating mass pair that can be swiveled along an oscillation path opposite the oscillating mass carrier 12. To that end, two roll-off elements 26 are received in respective cut-outs 28, 30 in the oscillating mass carrier 12 and in the oscillating mass 20 and are able to roll in the cut-outs 28, 30 to enable movement of the oscillating mass 20 along the oscillation path.

The oscillating masses 20 are received and supported on the oscillating mass carrier 12 exclusively with the aid of the two roll-off elements 26, making it possible to dispense with the additionally provided fastening elements and cut-outs in the oscillating mass carrier to receive the fastening elements for securing the oscillating masses 20. As a result, the oscillating masses 20 of an oscillating mass pair can be moved to a limited extent radially and circumferentially, in particular relative to each other.

The axial securing of the oscillating masses 20 of each oscillating mass pair to each other is effected by two retainers 36 placed on the roll-off element 26, so that a maximum axial movement of the oscillating masses 20 of an oscillating mass pair away from each other is limited. The retainers 36 are fixed axially firmly to the roll-off element 26 on the axially outer side of the oscillating mass 20, by the roll-off element 26 receiving the retainer 36, which is preferably designed as a circular-arc-shaped element. Together with the roll-off element 26, the retainer 36 can thus be moved in radial and circumferential directions relative to the oscillating mass 20.

FIG. 4 shows a three-dimensional view of a detail of the centrifugal force oscillating device 10 from FIG. 3. The retainer 36, designed as a ring-shaped element, is received on the roll-off element 26, and is secured in an axial direction pointing away from the oscillating mass 20 by an axially adjacent locking ring 38. To that end, the locking ring 38 is received in a recess 40 in the roll-off element 26, and thus prevents movement of the retainer 36 in the direction extending axially beyond the locking ring 38.

To secure the oscillating mass 20, the retainer 36 has a sufficiently large outside diameter so that the retainer 36 continues to be guidable along the axial lateral face of the oscillating mass 20, and does not slide into the cut-out 30 in the oscillating mass 20.

### REFERENCE VARIABLES

10 centrifugal force oscillating device
12 oscillating mass carrier
14 spring window
16 output hub
18 rivet element
20 oscillating mass
22 fastening element
24 cut-out
26 roll-off element
28 path
30 path
32 section
34 section
36 retainer
38 locking ring

What is claimed is:

1. A centrifugal force oscillating device (10) having oscillating masses (20) that are situated axially on both sides of an oscillating mass carrier (12) rotatable around an axis of rotation and form an oscillating mass pair, where the oscillating masses (20) can be swiveled to a limited extent along an oscillation path opposite the oscillating mass carrier (12) with the help of at least one roll-off element (26) that can be rolled off in cut-outs (28, 30) in both the oscillating mass carrier and the oscillating masses, and where the oscillating masses (20) can be moved to a limited extent axially relative to each other to form the oscillating mass pair, wherein the oscillating masses (20) of an oscillating mass pair are movable to a limited extent radially and/or circumferentially relative to each other.

2. The centrifugal force oscillating device (10) as recited in claim 1, wherein the roll-off element (26) accommodates a retainer (36) on the side lying axially outside in relation to the oscillating mass (20), to limit maximum axial movement of the oscillating masses (20) of an oscillating mass pair relative to each other.

3. The centrifugal force oscillating device (10) as recited in claim 2, wherein the retainer (36) is situated firmly on the roll-off element (26).

4. The centrifugal force oscillating device (10) as recited in claim 2, wherein the retainer (36) is designed as a ring-shaped element.

5. The centrifugal force oscillating device (10) as recited in claim 2, wherein the retainer (36) is secured axially in at least one direction by a locking ring (38) accommodated in a recess (40) in the roll-off element (26).

6. The centrifugal force oscillating device (10) as recited in claim 2, wherein the retainer (36) is movable circumferentially and/or radially together with the roll-off element (26), relative to the oscillating mass (20).

7. The centrifugal force oscillating device (10) as recited in claim 1, wherein a minimum axial distance between the oscillating masses (20) and the oscillating mass carrier (12) is defined by an axial projection formed on the oscillating mass carrier (12) and/or on the lateral face of the oscillating mass (20) that faces the oscillating mass carrier (12) axially.

8. The centrifugal force oscillating device (10) as recited in claim 7, wherein the axial projection is made in a single piece with the oscillating mass carrier (12) or the oscillating mass (20).

9. The centrifugal force oscillating device (10) as recited in claim 1, wherein a minimum axial distance between the oscillating masses (20) and the oscillating mass carrier (12) is defined by a collar formed on the roll-off element (26) and located axially in each case between oscillating mass (20) and oscillating mass carrier (12) and encircling the roll-off element (26).

10. The centrifugal force oscillating device (10) as recited in claim 1, wherein the oscillating masses (20) of an oscillating mass pair are received exclusively on the oscillating mass carrier (12) with the help of the roll-off element (26).
